(19) United States
(12) Patent Application Publication
(10) Pub. No.: US 2006/0198172 A1
(43) Pub. Date: Sep. 7, 2006

(54) Bridgeless boost converter with PFC circuit

(75) Inventor: Peter Wood, Rolling Hills Estates, CA (US)

Correspondence Address: OSTROLENK FABER GERB & SOFFEN, 1180 AVENUE OF THE AMERICAS, NEW YORK, NY, 100368403, US

(73) Assignee: International Rectifier Corporation

(21) Appl. No.: 11/392,039

(22) Filed: Mar. 29, 2006

Related U.S. Application Data
(63) Continuation-in-part of application No. 10/953,344, filed on Sep. 29, 2004.
(60) Provisional application No. 60/666,950, filed on Mar. 31, 2005.
(60) Provisional application No. 60/507,901, filed on Oct. 1, 2003.

(51) Int. Cl. H02M 7/04; H02M 5/42

(52) U.S. Cl. 363/89

(57) ABSTRACT

A boost type power supply circuit for providing a DC output voltage comprising first and second semiconductor switches coupled between respective input lines and a common connection; an AC input voltage from an AC source being supplied across the input lines; first and second diodes coupled in series with respective ones of the switches; third and fourth diodes coupled across respective ones of the switches in a free-wheeling relationship with the switches; an inductance coupled in at least one of the input lines; a controller for controlling the conduction times of the switches by providing a pulse width control signal to each of the switches; wherein the controller turns on at least one of the switches during a positive half cycle of the AC voltage to allow energy storage in the inductance and turns off the at least one switch to allow the energy stored in the inductance to be supplied to an attached load through one of the first and second diodes and one of the third or fourth diodes; and the controller turns on at least one of the switches during a negative half cycle of the AC voltage to allow energy storage in the inductance and turns off at least one switch to allow the energy stored in the inductance to be supplied to the attached load through one of the first and second diodes and one of the third and fourth diodes. The controller determines an on-time and an off-time of a pulse of the pulse width modulated control signal during each half cycle of the AC voltage, the on-time and off-time of the pulse being controlled to regulate said output voltage and to provide power factor correction of said AC input voltage, based on either voltage sensing or current sensing.

### CROSS REFERENCE TO RELATED APPLICATIONS

This application is based upon and claims priority of U.S. Provisional Ser. No. 60/666,950 filed Mar. 31, 2005 (IR-2965 PROV), incorporated by reference.

This application is a continuation-in-part of U.S. Ser. No. 10/953,344 filed Sep. 29, 2004 (IR-2593), incorporated by reference, which is based upon and claims priority of U.S. Provisional Ser. No. 60/507,901 filed Oct. 1, 2003, also incorporated by reference.

### BACKGROUND OF THE INVENTION

1. Field of the Invention

The present invention relates to a bridgeless boost converter with PFC circuit, and more particularly to a converter circuit usable, for example, in air-conditioning applications.

2. Related Art

The increased demand for in-room air conditioning systems driven by environmental changes has started to affect energy consumption during the summer time in all industrialized and emerging countries.

New government regulations and more energy-conscious consumers require better energy-efficient systems. However, finding a power management circuit solution that meets the criteria for full-scale efficiency and control poses a great challenge to designers in terms of costs, reliability and ease of design.

The quest for efficient use of power takes on even greater importance to designers of consumer products for household markets. One element of increased complexity is the input converter stage with power factor control, required by new regulations in Europe and China.

Because of the severity of the energy problem in almost every country, governments have deployed programs intended to considerably diminish the waste in energy consumption by raising the energy efficiency of appliance products such as clothes washers, water heaters, and particularly air-conditioners.

In-room and residential air conditioning is starting to have a large penetration not only in the USA and Japan but also in Europe and in many emerging countries including China and India.

In the USA, the Department of Energy has recently issued various new energy efficiency standards for most of the typical appliance products. Similar initiatives have already been in force in Europe and Japan.

The residential air-conditioning market (about 35M units manufactured worldwide) is by its nature a “high impact product” for the energy efficiency programs.

In the USA, final rules on air conditioners and heat pumps have established stringent minimum efficiency standards effective Jan. 23, 2006. By reducing the SEER (Seasonal Energy Efficient Ratio) of an air conditioning system, the annual operating cost can be reduced by 50-75 percent.

For air conditioning systems the economic savings is generally higher because of the intrinsic higher power of the compressor as compared to other appliance applications.

However, these savings are hardly achievable without a broader adoption of variable speed compressor drives running either a standard AC induction or a BLDC compressor. However, the adoption of electronic inverters for controlling the motor has generally not been enough to achieve these results.

The bridge rectifier/capacitor front-ends in these inverter circuits (as well as in linear and switch-mode power supplies) present highly nonlinear loads to the main line, as the input bulk capacitor charges only toward peaks of the voltage sine wave, thus inducing a peak of current, as shown in FIG. 1.

This non-sinusoidal current pulse contains therefore harmonics of the fundamental line frequency, each of them with a significant energy content.

These combined effects of poor power factor and harmonic disturbances, multiplied by a multitude of similar systems, often operating at the same time, reduce supply network capacity, in essence aggravating the energy problem, contributing to power distribution outages and shortages. Therefore, electronic motor controls of this type, in order to operate efficiently and within national and international standards, require the adoption of a power-factor correction circuit for the input section.

The existing standard EN/IEC61000-3-2 has four product classes, each having its own set of limits for harmonic currents and power factor.

The EN61000-3-2 standard applies to all products up to 16 amperes per phase and the existing standard classifies all motor driven equipment as Class-A, which are subject to the most strict limits. Various methods have been adopted by the industry to address the problem.

The simplest solution is a passive PFC topology, wherein for example a simple inductor is directly connected in series with the line. For the power level of an in-room air conditioning unit, the limitations of this spartan approach are too many: the size and weight of the inductor, the cost, and the poor power factor correction performance.

For better performance the only practical option is the adoption of an active PFC topology. However, an active PFC circuit is more complex and requires many more components, which if not selected properly may impact on the overall efficiency of the system.

The topology of FIG. 4 is normally used as a pre-regulator for a converter operating from a universal AC mains input. The converter can be a power supply or motor driver or any other power electronics circuit requiring compliance with power line quality standards.

It uses an off-line bridge rectifier with diodes D followed by a series inductor L and shunt switch M. The inductive stored energy is discharged into a reservoir capacitor C to form a regulated, low ripple voltage DC output. The circuit is suitable up to power levels of approximately 2.5 KW.

It is apparent from FIG. 4 that the power flow from the AC input to the DC load includes two diode drops in the rectifier and one in the boost diode DB. Additionally there is a voltage drop associated with the current sensing resistor R.

This increased complexity in power management circuit design adds further challenges to engineers and manufacturers.

Advances in semiconductor manufacturing and packaging technology are now available to power applications in appliances and light industrial markets to help in the solution of these new problems.

The trend in inverter applications toward integration of all power semiconductors into a single power package can easily extend to the input converter to address and help the solution of power management.

### SUMMARY OF THE INVENTION

New solutions to address these problems have been developed using the bridge-less configuration. This disclosure presents examples of high performance input converters, for example for compressor drives and motor control drives, which use new topologies and which may also use the proprietary iMotion packaging technology of the International Rectifier Corporation.

Among various power factor circuit topologies, bridgeless topologies disclosed in Ser. No. 10/953,344 (IR-2593) show promise for several reasons, especially for motor control applications and specifically for compressor drives in air-conditioning systems.

Referring to FIGS. 2 and 3, the operation of the basic topology will now be described, with respect to two conditions of the input voltage from the mains supply.

Positive Half-cycle

When the AC input voltage goes positive, the gate of MOSFET M1 is driven high and current IL flows from the input through the inductor, storing energy. When M1 turns off, energy in the inductor is released as current flows through D1, through the load and returns through the body diode of MOSFET M2 back to the input mains.

During the-off time, the current through the inductor L (which during this time discharges its energy), flows through the boost diode D1 and the circuit is closed through the load.

Negative Half-cycle

During the negative half cycle M2 turns on, and current flows through the inductor L, storing energy. When M2 turns off, energy is released as current flows through D2, through the load and back to the mains through the body diode of M1.

Note that the two MOSFETs may be driven simultaneously because of the presence of the body diodes that re-circulate the current during the opposite polarity cycle.

Thanks to the innovation of new silicon technology as well as advanced integration and packaging technology, this input converter topology can now be implemented effortlessly.

When compared with a conventional single switch, boost topology PFC circuit, a bridgeless topology offers efficiency gains as well as cost savings, more specifically:

Efficiency gain
One less diode in the power stream
Diodes across IGBTs do not need fast recovery, since they conduct at mains frequency and have lower V_{F}.
More efficient IGBTs.

Cost saving
No separate input AC rectifier.
Possibility to reduce the input filter.
Smaller heat sinks due to distributed heat sources and better efficiency.
Two smaller die size IGBTs (half current per switch).
Gate drive requirements are reduced due to smaller IGBT die total active area.

In view of these considerations, various embodiments of the invention provide a boost type power supply circuit for providing a DC output voltage comprising first and second semiconductor switches coupled between respective input lines and a common connection; an AC input voltage from an AC source being supplied across the input lines; first and second diodes coupled in series with respective ones of the switches; third and fourth diodes coupled across respective ones of the switches in parallel and/or in a free-wheeling relationship with the switches; an inductance coupled in at least one of the input lines; a controller for controlling the conduction times of the switches by providing a pulse width control signal to each of the switches; wherein the controller turns on at least one of the switches during a positive half cycle of the AC voltage to allow energy storage in the inductance and turns off the at least one switch to allow the energy stored in the inductance to be supplied to an attached load through one of the first and second diodes and one of the third or fourth diodes; and the controller turns on at least one of the switches during a negative half cycle of the AC voltage to allow energy storage in the inductance and turns off the at least one switch to allow the energy stored in the inductance to be supplied to the attached load through one of the first and second diodes and one of the third and fourth diodes. The controller determines an on-time and an off-time of a pulse of the pulse width modulated control signal during each half cycle of the AC voltage, the on-time and off-time of the pulse being controlled to regulate said output voltage and to provide power factor correction of said AC input voltage, based on either voltage sensing or current sensing.

Other features and advantages of the present invention will become apparent from the following description of embodiments of the invention which refers to the accompanying drawings.

### BRIEF DESCRIPTION OF THE DRAWINGS

FIG. 1 is schematic diagram showing the configuration and operation of a conventional inverter front end;

FIG. 2 is a schematic diagram showing a basic bridgeless converter topology as disclosed in Ser. No. 10/953,344, and its operation during a positive half-cycle;

FIG. 3 is a schematic diagram showing the converter of FIG. 2, and its operation during a negative half-cycle;

FIG. 4 is a schematic diagram of a conventional boost converter with PFC;

FIG. 5 is a schematic diagram of a bridgeless PFC circuit according to a first embodiment of the invention;

FIG. 6 is a schematic diagram of a bridgeless PFC circuit according to a second embodiment of the invention;

FIG. 7 is a schematic diagram of a bridgeless PFC circuit according to a modification of the first embodiment; and

FIG. 8 is a schematic diagram of a bridgeless PFC circuit according to a third embodiment of the invention.

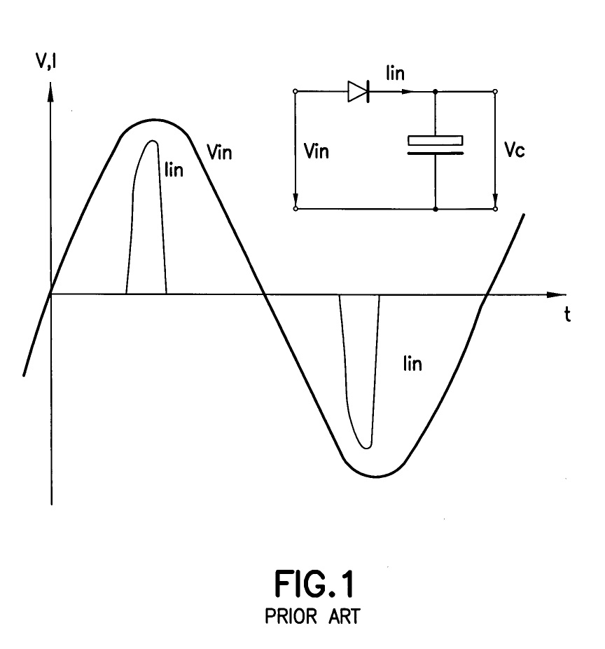

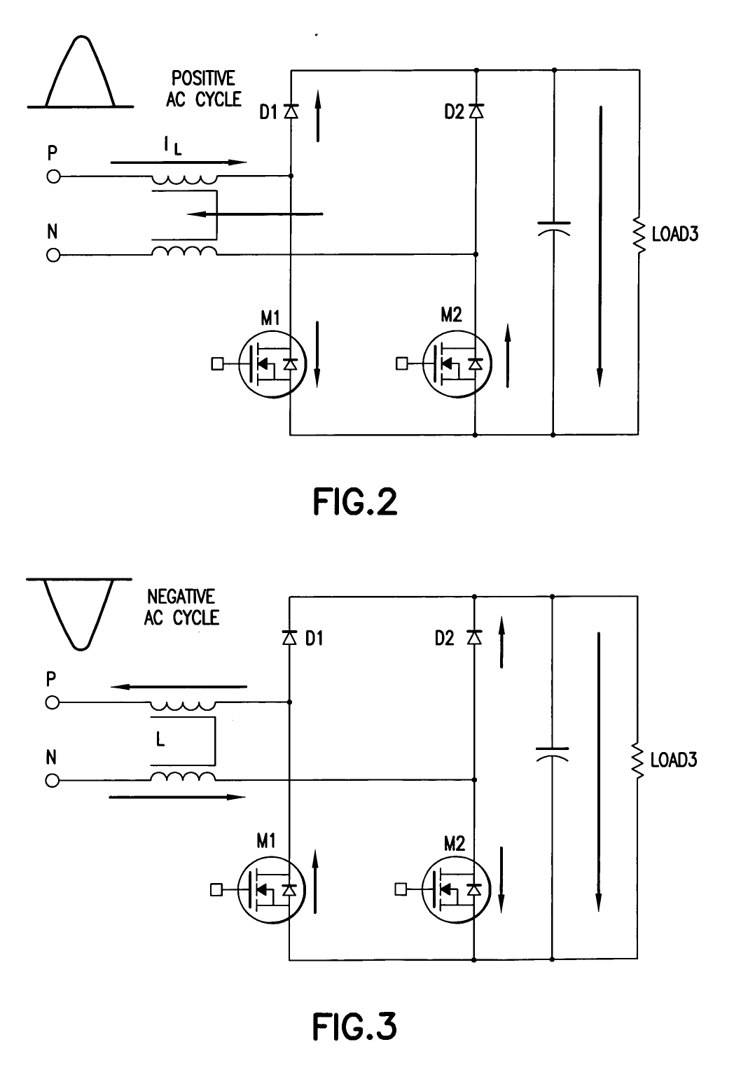

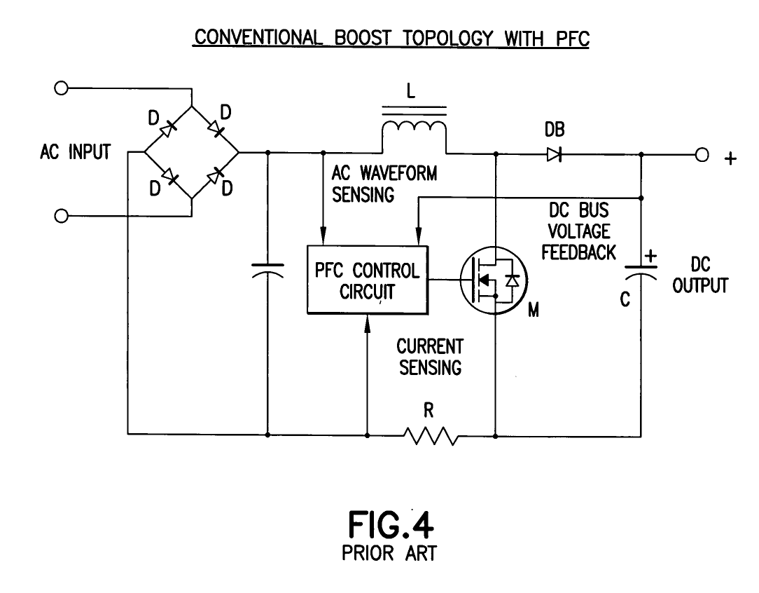

### DETAILED DESCRIPTION OF EMBODIMENTS OF THE INVENTION

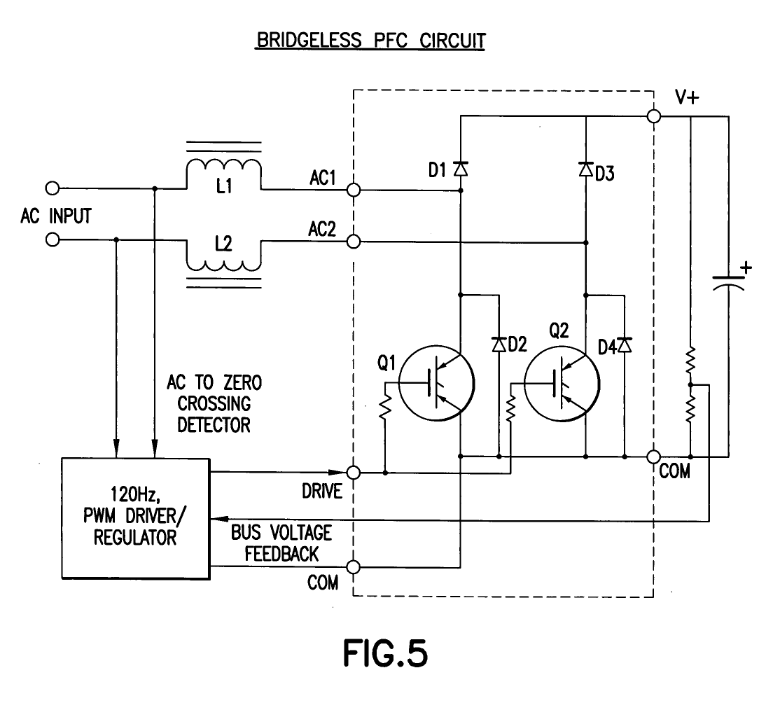

The circuit of FIG. 5 places the inductor(s) in the AC circuit, before the rectifier diodes D1-D4, so that D1 and D3 have the dual functions of rectification and boost diodes. It is apparent that the improved circuit has one less diode drop in the power flow. Since the circuit operates at 120 Hz, switching losses are virtually eliminated and D1-D4 and Q1-Q2 are standard speed components which have the added advantage of lower conduction losses than fast semiconductors. Q1 and Q2 may be IGBTs, for example.

The controller senses zero-voltage-crossing of the AC input signal and generates a PWM drive signal for the IGBT's Q1 and Q2.

The circuit delivers power factors of >0.99 without current sensing over typical line variations of +/− 10%. with efficiencies >98% in 230 VAC circuits delivering 1 KW at a DC bus voltage of 280 VDC.

The IGBT switches may be small (die size #2) since they conduct only on alternate half cycles even though they are driven simultaneously.

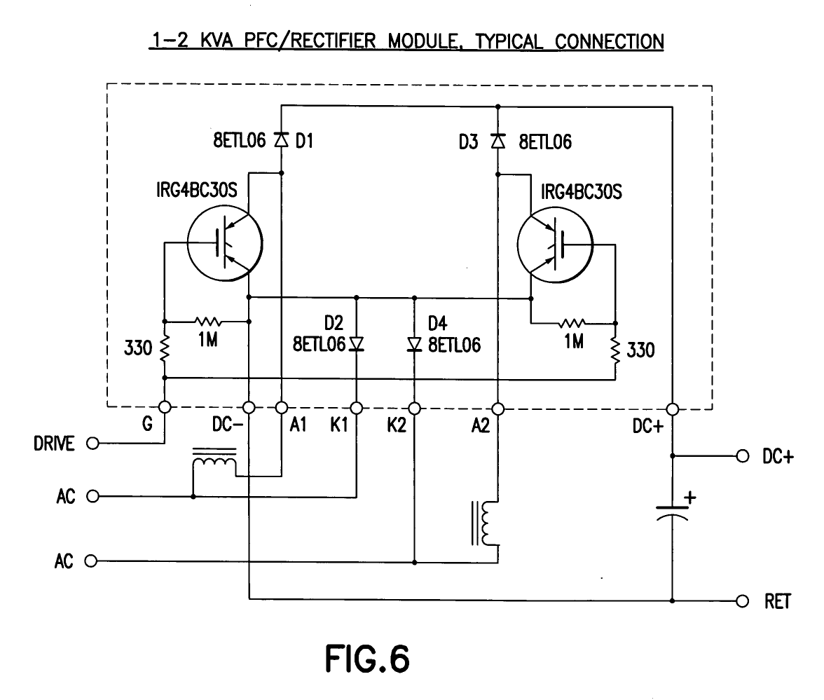

In the schematic of FIG. 6, two of the diodes (D2, D4) have their cathodes disconnected from the conventional bridge rectifier topology and are now connected to the mains side of the inductors. There is no difference in efficiency between the circuits of FIGS. 5 and 6. However, in FIG. 6, the inductors conduct only when each AC line is positive and not on the return current from the load and because of this, they have a DC flux component.

With this connection, the DC return bus is fixed and does not have the 120 Hz switching voltage of the previous circuit. The result is lower radiated EMI from the system.

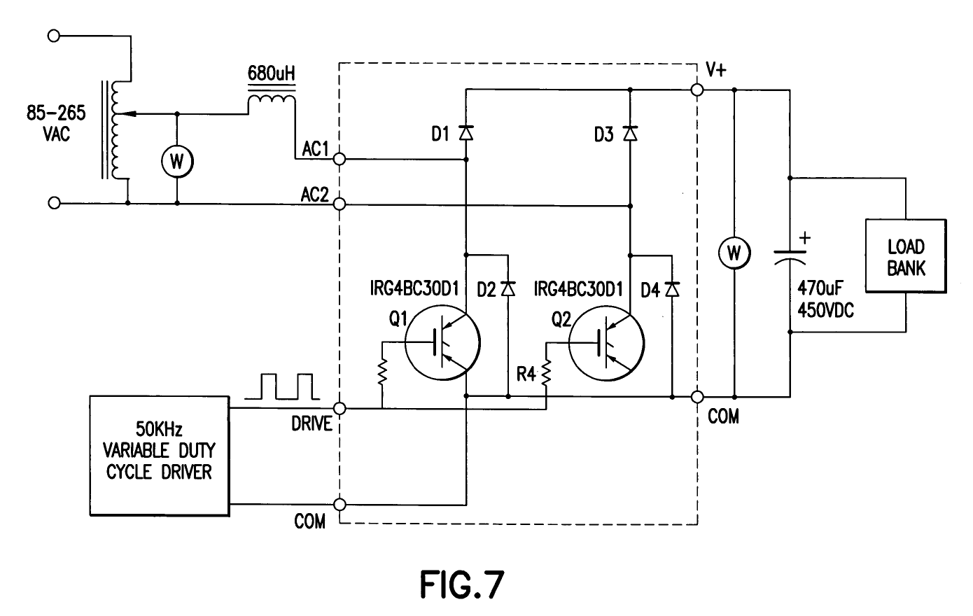

FIG. 7 shows a converter similar to that in FIG. 5 which was constructed in order to evaluate the efficiency of a complete input converter in bridgeless configuration. The circuit is aimed for 1200 W power (typical for 1200 btu/hour air-conditioning system). The power IGBT switches Q1, Q2 were driven using a dedicated gate driver circuit with a 50 KHz variable duty cycle generator providing the input signal.

The best performance was obtained using the most advanced silicon technology from International Rectifier Corp. In this case, the IGBT power switches were two IRGB20B06UPD1 Warp2 series while for the rectifier portion, four 8ETX06 diodes were optimized for the lowest recovery time and minimal recovery current. The following Table 1 shows the switching losses of the input converter as a function of the input line voltage and load power.

TABLE 1

| | | | IRGB20B60PD1 | | | |
|---|---|---|---|---|---|---|
| AC Input | | | | | Switching | |
| Voltage | Input Power | | E_{ON} | E_{OFF} | Loss | |
| 95 V | 300 | W | 73 | 133 | 10.3 | W |
| | 600 | | 198 | 292 | 24.5 | |
| | 900 | | 258 | 438 | 34.8 | |
| 265 V | 300 | W | 37 | 64 | 5.05 | |
| | 600 | | 117 | 96 | 10.65 | |
| | 900 | | 171 | 147 | 15.9 | |
| | 1200 | | 322 | 239 | 28.05 | |

The total input converter losses and efficiency were measured assuming the input voltage varying from a minimum of 95 V_{RMS} to a maximum of 265 V_{RMS} and 400 V_{DC} constant bus voltage. Tests were performed with a fixed switching frequency of 50 KHz. The overall losses here reported are considered a worst case scenario since the tests were carried out with the switches being operated at constant duty cycle across the range of input voltage for the preset bus voltage. In a normal application the duty cycle (in the case of continuous mode operation) is variable, reducing substantially the switching loss components. The following Table 2 shows the results obtained.

TABLE 2

| Input | Input | | Output | Output | | | |
|---|---|---|---|---|---|---|---|
| AC | AC | Input | DC | DC | Output | Total | |
| Voltage | Current | Power | Voltage | Current | Power | Losses | Eff |
| V | A | W | V | A | W | W | % |
| 95.5 | 4.02 | 308 | 400.6 | 0.7 | 275.7 | 32.5 | 89.5 |
| 95.4 | 8.10 | 621 | 399.5 | 1.4 | 560.0 | 61.0 | 90.2 |
| 95.6 | 12.30 | 951 | 400.3 | 2.1 | 845.3 | 105.7 | 89.9 |
| 265.6 | 2.03 | 292 | 399.5 | 0.7 | 285.0 | 7.0 | 97.6 |
| 265.7 | 4.00 | 586 | 400.2 | 1.4 | 572.0 | 14.0 | 97.6 |
| 265.5 | 5.87 | 880 | 400.3 | 2.1 | 854.0 | 26.0 | 97.0 |
| 265.2 | 7.75 | 1178 | 400.9 | 2.9 | 1143 | 35.0 | 97.0 |

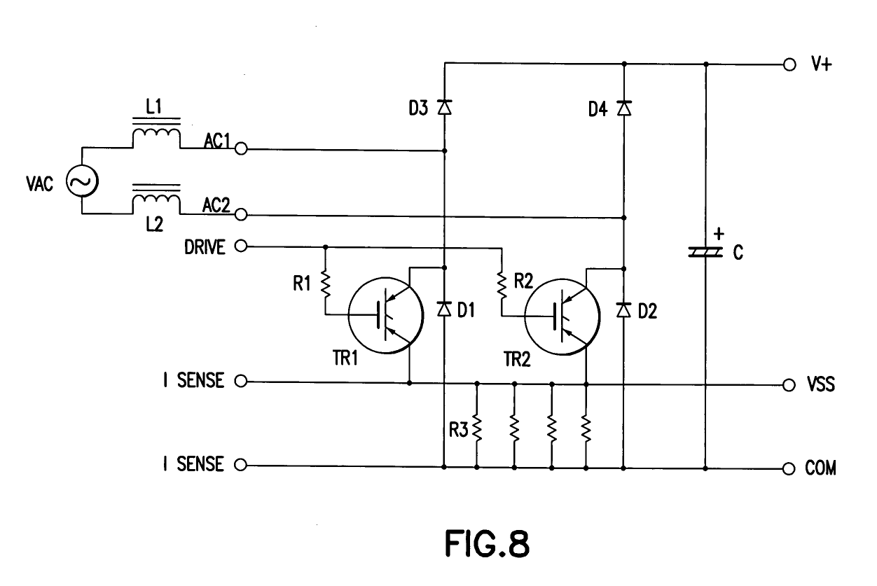

The test circuit of FIG. 7 was used to compare losses in a typical smart bridge configuration. In an actual PFC regulator, it is the practice to measure IGBT collector current independently of diode bridge current, as is done in the circuit of FIG. 8.

Warp2 series IGBTs (International Rectifier Corp.) are the device of choice for this topology and offer a great simplification in the current measurement and feedback, allowing for example the placement of current sensing in series with the diodes circuit and hence sensing a continuous current free of the switching components.

FIG. 8 shows another example of a bridgeless boost inverter circuit, including current sensing. The PFC function requires controlling the current drawn from the mains and shaping it to match the input voltage waveform. To accomplish this, the current is sensed at two terminals Isense and fed to the control circuit (not shown) which supplies a control signal DRIVE. Current sensing is achieved in this example by one or more current shunt resistor(s) R3 connected between the node of the anodes of D1 and D2 and the node of the emitters of TR1 and TR2. This arrangement is facilitated by the use of IGBT switches, rather than MOSFETs as in Ser. No. 10/953,344, because the free-wheeling diodes proved for the IGBT's are on separate chips, unlike the intrinsic body diode in the MOSFET structure. In this example, a common line COM is defined by the anodes of the diodes D1 and D2. The output capacitor C is provided between COM and a terminal V+ at the cathodes of the boost diodes D3 and D4.

Several additional criteria have been observed for the optimization of the bridgeless PFC to achieve improved performance. This goal can be addressed by selection of the IGBT gate driver. For efficient operation, it is important to minimize switching losses in the IGBTs.

A solid gate driver is able to operate at switching frequency >50 KHz and produces fast rise and fall times <100 nS (when loaded by two IRGB20B60) with Rg as low as 6.8 ohms. This driver function can be obtained by the adoption of an IR4427 IC driver, which has the desired dynamic and current output capabilities. As with all power switching circuits and regulators, layout is critical; hence the possibility to offer a simple plug & play solution with an integrated power module housing the input converter topology, the current sensing and the gate driver is the right answer to help electronic engineers facing the challenges of power management issues. With only 2 IR IPM modules, is possible today to integrate all the functions and circuits to address the power management functions of a typical driver for air-conditioning application.

Input converters with active PFC circuit and bridgeless topology, operating at high frequency, have been analyzed and power losses and efficiency advantages illustrated.

Benefits from these advancements have been shown, resulting in high efficiency converter operation, more than a 50% reduction in overall motor control system size, vastly reduced component counts, and reduced system cost and development time.

The disclosed power factor power topology and advanced packaging will help engineers to resolve new power management challenges in appliance systems for climate control. Thus, the engineering challenge to provide energy-efficient variable speed motor drive, respecting the standards for power factor correction, is addressed simply and cost effectively.

Although the present invention has been described in relation to particular embodiments thereof, many other variations and modifications and other uses will become apparent to those skilled in the art. Therefore, the present invention is not limited by the specific disclosure herein.

What is claimed is:

1. A bridgeless PFC boost converter comprising:
a boost inductor having a first end connected to a first AC input terminal and a second end connected to a first junction defined between the anode of a first diode and a first terminal of a first switch;
a second terminal of the first switch connected to a common line;
a parallel circuit of a capacitance and load terminals connected between the cathode of the first diode and the common line;
a series circuit of a second diode and a second switch connected between the cathode of the first diode and the common line;
a second AC input terminal connected to a second junction defined between the anode of the second diode and the second switch; and
a control circuit connected for controlling the first and second switches so as to provide power factor correction with respect to power applied to said load terminals.

2. A bridgeless PFC boost converter according to claim 1, wherein said first and second switches are IGBTs.

3. A bridgeless PFC boost converter according to claim 1, further comprising another boost inductor connected between said second AC input terminal and said second junction.

4. A bridgeless PFC boost converter according to claim 1, further comprising respective third and fourth diodes connected in parallel with said first and second switches, their cathodes being connected to the corresponding said first and second junctions.

5. A bridgeless PFC boost converter according to claim 4, wherein said IGBTs each have a pair of main terminals connected respectively to said common line and to the corresponding one of said first and second junctions; and a gate terminal connected to said control circuit.

6. A bridgeless PFC boost converter according to claim 5, further comprising a resistance network interconnecting said control circuit, said gate terminals, and said common line.

7. A bridgeless PFC boost converter according to claim 4, wherein said control circuit controls said first and second switches in response to current in said first and second switches.

8. A bridgeless PFC boost converter according to claim 4, wherein said control circuit controls said first and second switches in response to voltage at said first and second AC input terminals and to an output voltage across said load terminals.

9. A bridgeless PFC boost converter according to claim 8, wherein said control circuit senses zero voltage crossing at said AC input terminals.

10. A bridgeless PFC boost converter according to claim 4, wherein the anodes of the third and fourth diodes are connected to the common line.

11. A bridgeless PFC boost converter according to claim 1, wherein said control circuit controls said first and second switches in response to current in said first and second switches.

12. A bridgeless PFC boost converter according to claim 1, wherein said control circuit controls said first and second switches in response to voltage at said first and second AC input terminals and to an output voltage across said load terminals.

13. A bridgeless PFC boost converter according to claim 12, wherein said control circuit senses zero voltage crossing at said AC input terminals.

14. A bridgeless PFC boost converter according to claim 1, further comprising respective third and fourth diodes connected in parallel with said first and second switches, having their cathodes connected respectively to said first and second AC input terminals.

15. A bridgeless PFC boost converter according to claim 14, further comprising another boost inductor connected between said second AC input terminal and said second junction.

16. A bridgeless PFC boost converter according to claim 1, wherein said second terminals of said first and second switches are connected to a sensing line which in turn is connected to said common line by a shunt resistor.

17. A bridgeless PFC boost converter according to claim 16, wherein the anodes of the third and fourth diodes are connected to the common line.

18. A bridgeless PFC boost converter according to claim 16, wherein said control circuit controls said first and second switches in response to voltages on said sensing line and said common line.

19. A boost type power supply circuit for providing a DC output voltage comprising:
first and second semiconductor switches coupled between respective input lines and a common connection, an AC input voltage from an AC source being supplied across the input lines;
first and second diodes coupled in series with respective ones of the switches;
third and fourth diodes coupled across respective ones of the switches in a free-wheeling relationship with the switches,
an inductance coupled in at least one of the input lines;
a controller for controlling the conduction times of the switches by providing a pulse width control signal to each of the switches;
whereby the controller turns on at least one of the switches during a positive half cycle of the AC voltage to allow energy storage in the inductance and turns off at least one switch to allow the energy stored in the inductance to be supplied to an attached load through one of the first and second diodes and one of the third and fourth diodes; and
the controller turns on at least one of the switches during a negative half cycle of the AC voltage to allow energy storage in the inductance and turns off the at least one switch to allow the energy stored in the inductance to be supplied to the attached load through one of the first and second diodes and one of the third and fourth diodes; and
wherein
the controller determines an on-time and an off-time of a pulse of the pulse width modulated control signal during each half cycle of the AC voltage based on at least one input without requiring sensing of the input current from the AC source;
the on-time and off-time of the pulse being controlled to regulate said output voltage and to provide power factor correction of said AC input voltage.

20. The circuit of claim 19, further comprising a detection circuit providing an input to said controller to determine a beginning of each half cycle of said AC voltage and wherein said on-times represent a first time period following said beginning of each half cycle and said off-times represent a second time period following said beginning of said half cycle, said pulse having a pulse width determined by the time difference between said on-time and said off-time; and said on-times and off-times being selected to provide power factor correction.

21. The circuit of claim 20, wherein said detection circuit to determine a beginning of each half cycle comprises a zero crossing voltage detection circuit.

22. The circuit of claim 21, wherein one of said inputs to said controller comprises an output of said zero crossing voltage detection circuit.

23. The circuit of claim 19, wherein the at least one input to said controller comprises a voltage related to the output voltage of said circuit, whereby the output voltage is regulated within a predefined regulation range by controlling said pulse width.

24. The circuit of claim 23, wherein the voltage related to the output voltage is developed across a voltage divider circuit.

25. The circuit of claim 23, wherein the at least one input comprises a signal determining the beginning of each half cycle of said AC input voltage, said controller providing a pulse width modulated signal with said determined on-time and off-time to provide power factor correction of said AC input voltage.

26. The circuit of claim 19, wherein said switches comprise IGBTs.

27. The circuit of claim 19, further comprising an output capacitor across which said output voltage is developed.

28. The circuit of claim 19, wherein said inductance comprises first and second inductors disposed in each of said input lines.
